(19) United States
(12) Patent Application Publication
(10) Pub. No.: US 2011/0093131 A1
(43) Pub. Date: Apr. 21, 2011

(54) Energy saving for household appliances

(76) Inventor: Dipak R. Biswas, Northborough, MA (US)

(21) Appl. No.: 12/589,080

(22) Filed: Oct. 19, 2009

(51) Int. Cl. G06F 1/32

(52) U.S. Cl. 700/296

(57) ABSTRACT

The house hold appliances, such as refrigerators and freezers are usually turned on all day (24/7) long. They consume electricity throughout day and night. The flow of electricity through these appliances can be controlled for a finite period of time so that the food or other stored products are not going to be spoiled. The consumption of electricity can be reduced significantly by using a programmable timer or time switch. The programmable timer or time switch can be plugged into the wall and the power chord of the refrigerator or freezer can be plugged into the timer. The timer or time switch can be built-in to the appliances. The refrigerator or freezer with a built-in timer will control the flow of electricity by deliberately shutting of the power for a fixed period of time. A significant amount of energy can be saved by using the proposed method of deliberately shutting off the power for a fixed period of time using a timer or time switch which can be built-in to the appliances or they can be individual unit where the appliances can be directly plugged in.

### BACKGROUND OF THE INVENTION

The present invention is in the field of energy saving for house hold appliances. More particularly, the present invention is in the technical field of refrigerators and freezers.

Electrical energy conservation is utmost important in light of the cost of producing and usage of electricity. In recent years, the price of fuel went up significantly resulting in increased cost of production of electricity. Energy conservation is one of the major concerns for reducing the consumption of electricity for different household, commercial and industrial applications. United States being the largest consumer of energy, there is an urgent need to conserve energy by utilizing energy efficient devices and minimizing the waste. Twenty-two percent of all energy in the United States is used for residential purposes. As the generation of electricity is so inefficient, it accounts for 71 percent of household carbon emissions. Typically a home's electrical use may be responsible for more CO₂ emissions than the two cars in the driveway, according to The Christian Science Monitor. Recent awareness of global warming and energy conservation, global people celebrated an Earth Hour (CNET News, Mar. 27, 2009).

“Earth hour is a sort of open-source movement against global warming. On Saturday, Mar. 28, 2009 at 8:30 p.m. in each time zone, millions of people in thousands of cities turned off the lights for one hour to raise people's consciousness about the link between global warming and energy use.” Therefore, using less the electricity will lead to conserve energy usage.

Typically the refrigerators and freezers are the cooling appliances to store foods. Foods which can get spoiled at normal temperature can be stored at a much lower temperature in the refrigerator. Typical refrigerator temperature in the fresh food compartment is around 37° F. Freezers on the other hand keep the foods frozen. Typically freezers temperature is around 0° F. These temperatures can fluctuate due to automatic defrost cycle, cycling of compressor and opening and closing the refrigerator and freezer doors. Room temperature and the amount of food storage in refrigerator and freezer can also affect the temperature fluctuation. A thermostat in the freezer controls the cycling of compressor along with an adaptive defrost control board. Normally a refrigerator has a freezer with it or the freezer can be a separate appliance. Both refrigerators and freezers are used in household, industrial and commercial sectors, such as restaurants, hospitals, etc.

Typically, refrigerators can be either on the top or bottom of the freezer and side-by-side refrigerators with a freezer compartment and a refrigeration compartment positioned to the left and right of one another.

Refrigerators and freezers consist of two components, a condenser coil and an evaporator coil. A refrigerant vapor is circulated in a compressor and the vapor is compressed to a high pressure superheated vapor which passes through condenser tubes. A fan blows air from the refrigerator or freezer across these tubes and the refrigerant completely vaporizes and the cold air is circulated in the refrigerator to maintain the cold temperature. Normally a refrigerator has a freezer and some of the newer refrigerator has other features, such as automatic defroster, ice maker and chilled water supply.

Most of the refrigerators made after year 2000 consume much less power. For refrigerator alone, U.S. house hold used nearly 14% electricity in 2001 (the highest was for air conditioning which was 16%). The cost of electricity is 12 cents/kWh for US National average. A typical household in US consumes about 11,000 kWh per year. In 2001, US household consumed about 1462 kWh average electricity for refrigeration.

### Example 1

In 2001, total amount of electricity consumed by 107 million US household was 1,140 billion kWh. Out of that, the amount of electricity used for refrigerator alone in was 156 billion kWh. In US, 107 million household with one refrigerator used 1458 kWh of electricity in 2001. It was also reported that ˜14% of total household electricity was consumed by refrigerators. In addition, freezers consumed 3.5% of total electricity.

House hold appliances, such as refrigerator and freezer are being operated day and night to preserve and protect food and other stored items. They are consuming electricity for 24/7/365 days. It is an object of this invention to provide a method of reducing the consumption of electricity for house hold appliances. It is another object to provide such an arrangement by deliberately shutting off the electric power for a fixed period of time. It is still another object to provide such arrangement which is going to preserve the foods and other stored items during this shutting off period.

### BRIEF SUMMARY OF THE INVENTION

In accordance with one embodiment of the invention, the present invention relates to a method of saving household electric power consumption be deliberately shutting off the electric power by placing a timer or time switch between the power source and the appliances, such as refrigerator or freezer. The current refrigerator or freezer does not have a built-in timer for shutting off the power deliberately. The intent of this invention is to shut off the supply of electricity for a fixed duration. This function can be achieved by controlling the electric supply using a programmable timer or a time switch. The timer will allow to flow of electricity continuously with a provision of shutting off the flow of electricity for a fixed duration. The timer can be used to control the sequence of events, flow of electricity in this case. U.S. Pat. No. 3,824,418, describes a wall plug-in time switch, U.S. Pat. No. 3,997,742, describes an automatic time switch, U.S. Pat. No. 4,171,471, describes a programmable timer, U.S. Pat. No. 4,712,019 describes a programmable electronic plug-in timer and U.S. Pat. No. 6,903,284, describes timed switch control for electric devices. The built-in timer or time switch in the refrigerator or freezer or a separate timer or time switch for a refrigerator or freezer can save a significant consumption of electrical energy.

### BRIEF DESCRIPTION OF THE DRAWING

FIG. 1. is a perspective view of the flow of electricity through a timer (1) into the refrigerator or freezer (2).

FIG. 2. is a perspective view of the flow of electricity through a built-in timer (1) into the refrigerator or freezer (2).

### DETAILED DESCRIPTION OF THE INVENTION

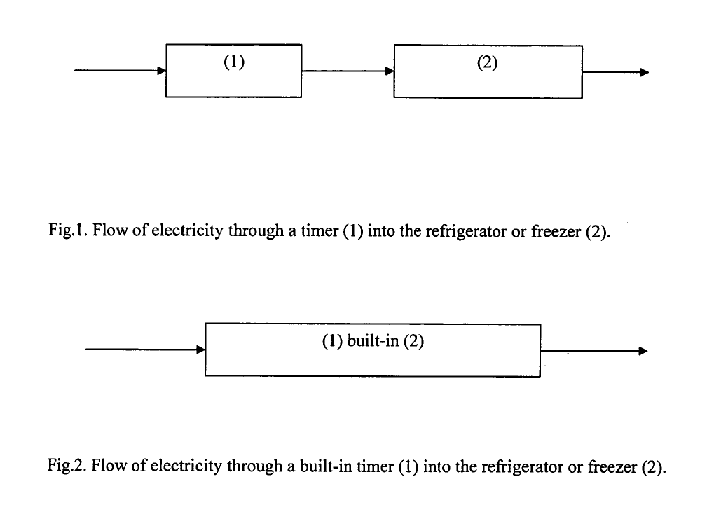

Typically many of the household, restaurants, hospitals, etc. use appliances, such as refrigerators and freezers which are turned on all day (24/7) long. Referring now to the invention in more detail, in FIG. 1 it is shown the flow of electricity through a timer (1) into the refrigerator or freezer (2). The timer can be a programmable timer which will control the flow of electricity with a provision of shutting off the flow for a fixed period of time. After that the normal flow of electricity will resume. The programmable timer can be plugged into the wall and the power chord of the refrigerator or freezer can be plugged into the timer. Referring now to the invention in more detail, in FIG. 2 it is shown a perspective view of the flow of electricity through a built-in timer (1) into the refrigerator or freezer (2). The built-in timer will control the flow of electricity with a provision of shutting off the flow for a fixed period of time.

The programmable timer for selectively controlling the flow of electricity into the refrigerator or freezer consists of: a) housing, b) a male plug extending from the timer to an electrical socket on the wall, c) a female plug mounted to the housing of the timer for connecting to the appliance. The programmable timers can be mechanical or electronic. Electronic timer has higher precision than the mechanical timers. Electronic timers can be analog or digital.

The advantage of the present invention include, without limitation, is to reduce the electric power consumption for house hold appliances, such as refrigerators and freezers.

### Example 2

Using the statistical numbers from the example 1, one 60 min/day shutting off the flow of electricity will have a potential saving of nearly 4% of total electricity consumed. By taking into consideration of having an additional freezer and also considering the number of refrigerators and freezers in commercial sector, it is clearly seen that by utilizing this method of controlling electricity in appliances, this country alone can reduce electricity consumption significantly amounting to billions of dollars.

Once appliances are turned off, the power is expected to be off. Now many appliances with remote controls, clocks or microprocessors are designed with ‘standby’ features. They are drawing electricity continuously for 24 hours a day, seven days a week.

These household items, such as cell phone charger, kitchen appliances like microwaves, rice cookers, bread makers, and coffee pots also typically use less than 5 watts. Other items, such as Tivo, cable boxes or satellite dish boxes, CD player, VCRs, DVD players, computers, printers, cable modems/DSL, TVs often use 10 to 50 watts each while turned off or in standby mode. There's no reason to leave them plugged in when they are not in use. These little things add up in substantial power consumption. This is termed as phantom load, standby power, vampire power or leaking electricity. Every year, US consumers waste an estimated $4 billion on these phantom loads, which amounts to about 5 percent of the country's total electricity load, according to a study by Lawrence Berkeley National Laboratory.

In broad embodiment, the present invention is to reduce the electric power consumption in house hold appliances, such as refrigerators and freezers by using any programmable timer which will deliberately shut off the flow of electricity for a finite period of time.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not limited by the above described embodiment, method, and examples, but by all embodiments and methods within the scope and spirit of the invention as claimed.

### Experiment 1:

Refrigerator: Kenmore, 2007 Model: 106.5656, Serial: SR4639675, Type: 26SSA (26 cu.ft, Energy Star Refrigerator).

One end of a Kill A Watt device—an electricity usage monitor (Commercially available—P3 International Corporation) for monitoring the volt (V), ampere (A), watt (W), Hz and kWh was attached to the refrigerator plug and the other end was plugged in to an electrical outlet (as shown in FIG. 1 with a Kill A Watt device). The kWh was monitored for 24 hours and determined the amount of kWh usage per day. Then a mechanical timer (Westinghouse, 24 Hour Mechanical Timer) was placed in between the Kill A Watt and the wall plug (as shown in FIG. 1) and monitor the kWh/day with a provision of automatic power shut off for one hour. A typical 24 hour data is shown below:

For a 24 hour period, the power consumption was 1.20 kWh. With a timer controlling for an hour power off, the power consumption was 1.15 kWh for a 24 hour period (0.05 kWh power saving for one hour power stoppage).

Therefore, for one hour power off per day can save 0.05/1.20×100=4.2% of electricity consumption. It was also observed that the inside temperature of 37° F. for refrigerator and 0° F. for the freezer (built in for this model) were unchanged after the one hour power off cycle. If the power shut off can be programmed at times when the refrigerator is not being used, typically middle to late night, there will be no temperature rise due to opening and closing the refrigerator door. In addition, it is recommended to keep the refrigerator coil clean at all times.

Continuous monitoring the power consumption (without cutting off the power) for different period of time, such as 48 hours, 72 hours, 96 hours and 168 hours was also performed. The results are summarized below:

| | Power consumption | Average | Per hour consumption |
|---|---|---|---|
| Hours | kWh | kWh | kWh |
| 24 | 1.20, 1.32, 1.16, 1.44 | 1.28 | 0.053 |
| 48 | 2.39, 2.31, 2.40, 2.51 | 2.40 | 0.050 |
| 72 | 3.63, 3.38, 3.68, 3.80 | 3.62 | 0.050 |
| 96 | 4.95, 4.85, 5.01, 4.95 | 4.94 | 0.051 |
| 168 | 9.57, 9.24, 9.35, 9.45 | 9.40 | 0.056 |

For each 24 hours period, with a timer controlling for an hour power shut off, the average power saving of 0.05 kWh was observed.

The above experiments using a programmable timer and not shutting off the power for 48 hours, 72 hours, 96 hours, and 168 hours show average power consumption with normal operating condition (meaning the door opening and closing for daily use) was nearly 0.05 kWh which is consistent with the experiment with the power shut off in a 24 hour period.

Using the values from the Example 1, in 2001, the amount of electricity used for refrigerator alone was 156 billion kWh. In USA, for a total of 107 million household with one refrigerator used $17.47B worth of electricity where the retail price of the electricity was $0.112 kWh. By shutting off electricity for one 60 minutes/day, the electricity consumption can be reduced nearly 4% of the total electricity for running one refrigerator. It amounts to a potential saving of nearly $700M/yr. If a household has an additional refrigerator and a freezer and also considering the number of refrigerators and freezers used in the commercial sectors, such as restaurants, offices, hospitals, the potential energy saving amounts to billions of dollar per year.

I claim:

1. A method of saving electric power consumption for at least one appliance comprising incorporating at least one timer or time switch for deliberately shutting off the electric power from an external source to said appliance for at least one predetermined period of time, or at a preset sequence during the use of the appliance.

2. The method according to claim 1, wherein said appliance is a household or commercial refrigerator or freezer.

3. The method according to claim 1, wherein said appliance is an industrial refrigerator or freezer.

4. The method according to claim 1 wherein said timer or time switch is a separate unit that is directly plugged into an external power source on one end and to said appliance on the other end.

5. The method according to claim 1 wherein said timer or time switch is built into said appliance, and is directly connected into the external power source.

6. The method according to claim 1 wherein said timer or time switch is programmable.

7. The method according to claim 1 wherein said timer or time switch is mechanical.

8. The method according to claim 6 wherein said timer or time switch is electronic and is analog or digital.

9. The method according to claim 1 wherein said timer or time switch has one interval cycle or multiple cycles per period of time.

10. The method according to claim 9 wherein said period of time is selected from the group consisting of a day, a week, a month, or a year.

11. An appliance comprising at least one built-in or attached timer or time switch for deliberately shutting off the electric power from an external source to said appliance for at least one predetermined period of time, or at a preset sequence during the use of the appliance.

12. An appliance according to claim 11, wherein said appliance is a household refrigerator or freezer.

13. An appliance according to claim 11, wherein said appliance is an industrial refrigerator or freezer.

14. An appliance according to claim 11 wherein said timer or time switch is a separate unit that is directly plugged into an external power source on one end and to said appliance on the other end.

15. An appliance according to claim 11 wherein said timer or time switch is built into said appliance, and is directly connected into the external power source.

16. An appliance according to claim 11 wherein said timer or time switch is programmable.

17. An appliance according to claim 11 wherein said timer or time switch is mechanical.

18. An appliance according to claim 16 wherein said timer or time switch is electronic and is analog or digital.

19. The method according to claim 11 wherein said timer or time switch has one interval cycle or multiple cycles per period of time.

20. The method according to claim 19 wherein said period of time is selected from the group consisting of a day, a week, a month, or a year.
